(19) United States
(12) Patent Application Publication
(10) Pub. No.: US 2024/0421669 A1
(43) Pub. Date: Dec. 19, 2024

(54) ROTOR FOR AN EXTERNALLY EXCITED SYNCHRONOUS MACHINE

(71) Applicant: MAHLE International GmbH, Stuttgart (DE)

(72) Inventor: Thorsten Grelle, Stuttgart (DE)

(21) Appl. No.: 18/704,447

(22) PCT Filed: Sep. 6, 2022
(86) PCT No.: PCT/EP2022/074675

§ 371 Date: Apr. 24, 2024

(30) Foreign Application Priority Data
Oct. 25, 2021 (DE) 10 2021 212 012.1

(51) Int. Cl. H02K 11/042; H02K 1/32

(52) U.S. Cl. CPC H02K 11/042; H02K 1/32

(57) ABSTRACT

A rotor for an externally excited synchronous machine may include a rotor winding and a rectifier. The rotor winding may be arranged on a hollow rotor shaft. The rectifier may be electrically connected to the rotor winding. The rectifier and a rotary transformer rotor of a rotary transformer with a secondary coil may be arranged in the hollow rotor shaft.

### CROSS-REFERENCE TO RELATED APPLICATIONS

This application claims priority to International Patent Application No. PCT/EP2022/074675, filed on Sep. 6, 2022, and German Patent Application No. DE 10 2021 212 012.1, filed on Oct. 25, 2021, the contents of both of which are hereby incorporated by reference in their entirety.

### TECHNICAL FIELD

The invention relates to a rotor for an externally excited synchronous machine. In addition, the invention relates to an externally excited synchronous machine or a traction motor for a motor vehicle or a servomotor having such a rotor.

### BACKGROUND

So-called externally excited synchronous machines require in their rotor an electric direct current for generating the magnetic rotor field. This operation is referred to as “rotor excitation”. In conventional synchronous machines, the electric rotor current is transmitted to the rotating rotor with the help of so-called carbon brush slip ring contacts. There it has proved to be disadvantageous that the carbon brushes, especially at high rotational speeds, wear down and in the process can produce undesirable electrically conductive carbon dust.

Alternatively to such a transmission of the electric direct currents with the help of slip rings it is known to realise the electric current transmission to the rotating rotor inductively, i.e. wirelessly. The function principle of the said inductive energy transmission is based on an electric transformer, wherein the primary coil of the transformer is arranged fixed on the synchronous machine and the secondary coil on the rotating rotor. Since with the inductive energy transmission in the secondary coil an electric alternating current is always generated initially it is necessary to electrically rectify the generated electric AC voltage with the help of a suitable rectifier circuit, which can likewise be arranged on the rotor, i.e. to convert the same into an electric DC voltage.

With currently known externally excited synchronous machines, rotary transformers are employed for the contactless energy transmission into the rotor, which rotary transformers are located outside a rotor shaft. The greater a circumference of a secondary coil of the rotary transformer non-rotatably connected to the rotor shaft is, the greater become the forces that occur during the operation of the synchronous machine, in particular centrifugal forces, which have an effect on the secondary coil that is non-rotatably arranged on the rotor shaft and a rectifier that is likewise non-rotatably arranged on the rotor shaft. In addition to this, the magnetic field of the stator winding of the electric externally excited synchronous machine can negatively affect the function of the rotary transformer.

### SUMMARY

The present invention therefore deals with the problem of stating for a rotor of the generic type an improved or at least an alternative embodiment, which in particular overcomes the disadvantages known from the prior art.

According to the invention, this problem is solved through the subject matter of the independent claim(s). Advantageous embodiments are the subject matter of the dependent claim(s).

The present invention is based on the general idea of reducing magnetic interference effects and mechanical forces acting on a rotary transformer of a rotor for an electric externally excited synchronous machine or a traction motor for a motor vehicle or a servomotor in that, for energy transmission to the rotor, a part of the rotary transformer that is non-rotatably connected to the rotor is arranged within a rotor shaft of the rotor. Through this compact design radially relatively close to an axis of rotation of the rotor, the centrifugal forces occurring during the operation, i.e. during a rotation of the rotor, can likewise be reduced such as for example magnetic fields acting from the outside, i.e. from a stator winding of the electric externally excited synchronous machine on the rotary transformer, as a result of which the mechanical load and also an interference caused by the magnetic interference fields can be significantly reduced. The rotor according to the invention for the externally excited synchronous machine has the previously mentioned hollow rotor shaft, on the outer lateral surface of which the rotor winding is arranged. Likewise provided is a rectifier that is electrically connected to the rotor winding. According to the invention, the rectifier and a secondary coil of a rotary transformer rotor are now arranged within the hollow rotor shaft. Thus, the previously mentioned effects, namely a significant improvement of the electromagnetic compatibility through an optimised shielding by way of the rotor shaft and an improvement of the mechanical stability through arrangement both of the rectifier and also of the secondary coil on very small diameters can be achieved. In addition it is possible to utilise an installation space previously unutilised within the hollow shaft, as a result of which the synchronous machine as a whole can be built in a more compact manner. In the following description, only a synchronous machine is referred to for the sake of easier readability, wherein it is obviously clear that the rotor can also be employed for a traction motor for a motor vehicle or a servomotor.

Practically, the rectifier and the secondary coil form a prefabricated assembly. For installation of the rectifier and of the secondary coil in the hollow rotary shaft it is of great advantage when these form a contiguous prefabricated or prefabricatable assembly, which can be installed as a common component in the hollow shaft. In particular, an electrical contacting of the secondary coil with the rectifier can thus be significantly simplified for example.

Practically, the secondary coil and the rectifier are glued, welded, soldered, screwed, pressed, clipped to one another and/or cast with one another, such as for example embedded in a plastic matrix. Even this incomplete enumeration shows the manifold possibilities of coupling the rectifier to the secondary coil that are possible, in particular encapsulating the secondary coil and of the rectifier in a plastic casing simultaneously brings about an electrical insulation of the components towards the outside. A gluing also represents a comparatively simple connecting process that can be carried out quickly. In order to improve for example a repair possibility, the secondary coil and the rectifier can also be clipped or screwed to one another, as a result of which with for example a defective rectifier the assembly can be removed from the hollow rotor shaft, the rectifier exchanged, replaced with a new and functioning rectifier and the assembly consisting of the new rectifier and the secondary coil can then be again placed into the hollow rotor shaft of the rotor.

In a further advantageous embodiment of the solution according to the invention, the assembly comprises fluid-permeable openings, so that a coolant can flow in the hollow rotor shaft. Thus, in particular an optimised cooling both of the rectifier and also of the secondary coil is particularly easily possible. By, for example embedding the secondary coil and the rectifier, i.e. the assembly, in a fluid-tight plastic casing, an electrical insulation can be additionally achieved so that as coolant an electrically conductive fluid can also be used in principle.

In an advantageous further development of the solution according to the invention, the secondary coil is arranged annularly about an axis of rotation of the hollow rotor shaft. This annular configuration or arrangement of the secondary coil makes possible an optimised inter-engaging assembly with a transformer core comprising a primary coil of a rotary transformer stator of the rotary transformer.

Further, the present invention is based on the general idea of equipping an externally excited synchronous machine or a traction motor for a motor vehicle or a servomotor with an electrically energizable rotor according to the preceding paragraphs and a rotary transformer stator which is arranged in the hollow rotary shaft and thereby transfer the advantages that can be achieved with respect to the rotor to the synchronous machine. Specifically, the advantages are a compact design, an improvement of the electromagnetic compatibility through an arrangement of the rotary transformer within the hollow rotor shaft, as a result of which the rotor shaft itself serves as magnetic shield. At the same time, a significant improvement of the mechanical stability of the rotary transformer can also be achieved since both the rectifier and also the secondary coil of the rotary transformer rotor can be placed on a very small pitch circle diameter and thus be subjected to low centrifugal forces during the operation.

In an advantageous further development of the externally excited synchronous machine, the rotary transformer stator comprises a primary coil and a transformer core of a magnetic core material, for example of a ferrite. The rotary transformer stator has the primary coil interacting with the secondary coil of the rotary transformer rotor and with installed synchronous machine is likewise protected within the hollow rotor shaft and thus both optimised in terms of installation space and also optimised in terms of an effect of parasitic influences such as magnetic interference fields, as well as forces such as centrifugal forces.

Practically, the transformer core comprises an inner ring, an outer ring and a web connecting the inner ring and the outer ring in each case on an end-face, wherein the primary coil is arranged on the inner ring and between the inner ring and the outer ring an annular recess is provided. The secondary coil of the rotary transformer engages in this annular recess during the operation, as a result of which an installation space-optimised solution can be created. In particular, an installation of the rotary transformer by simply inserting the secondary coil into the recess of the transformer core can thus be performed very easily. Analogously, the primary coil can also be arranged on the outer ring and between the inner ring and the outer ring an annular recess be provided, into which the secondary coil of the rotary transformer engages during the operation.

In a further advantageous embodiment of the externally excited synchronous machine, the rotary transformer stator is arranged on a bearing pin for mounting the rotor. Obviously it is conceivable that the rotary transformer stator is also arranged in a different place, for example on a housing of the externally excited electric synchronous machine, wherein by the bearing pin a bearing point located near the rotary transformer can be provided at the same time, which reliably ensures the annular gaps existing between the secondary coil and the recess in the transformer core. Thus, a smooth rotary motion of the rotor can be ensured in the long term.

Practically, the bearing pin comprises a cooling channel for conducting coolant. Such a cooling channel can for example pass through the bearing pin in the axial direction and in particular also coaxially, as a result of which the entire rotary transformer arranged within the hollow rotor shaft can be cooled via the coolant. Thus, a higher output of the externally excited synchronous machine can be achieved in particular through an active cooling of the rotor.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description.

### BRIEF DESCRIPTION OF THE DRAWINGS

Therein it shows in each case schematically:

FIG. 1 shows a longitudinal sectional representation through a rotor according to the prior art,

FIG. 2 shows a sectional representation through a rotor according to the invention with a rotary transformer rotor arranged within a hollow rotor shaft,

FIG. 3 shows a sectional representation through a bearing pin for mounting the stator of the rotary transformer (primary coil) in an externally excited synchronous machine,

FIG. 4 shows a sectional representation through the externally excited synchronous machine according to the invention.

### DETAILED DESCRIPTION

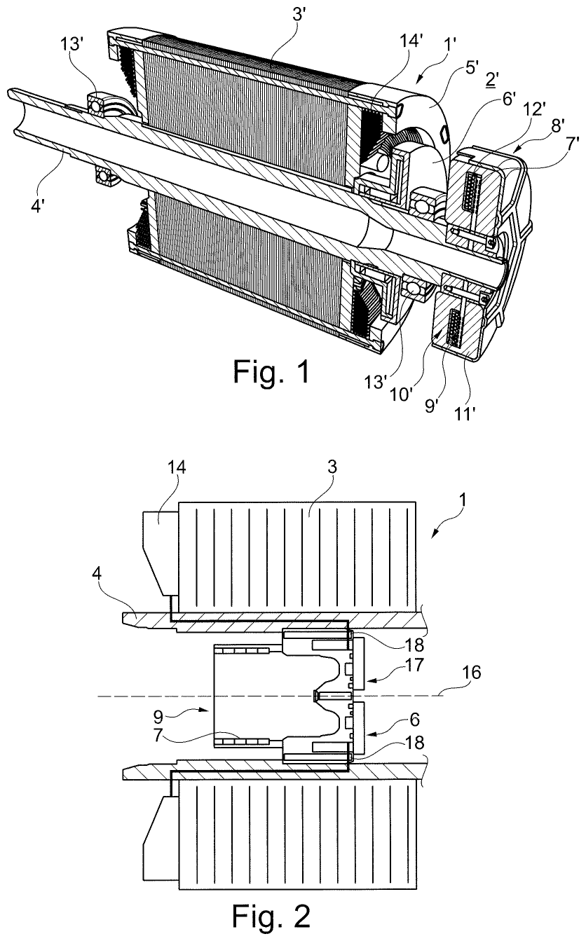

According to FIG. 1, a rotor 1′ for an externally excited synchronous machine 2′ comprises a rotor winding 3′, which is arranged on a hollow rotor shaft 4′. The rotor 1′ likewise comprises a balancing ring 5′ and a rectifier 6′, wherein any unbalances that may occur can be offset via the balancing ring 5′. The rectifier 6′ in turn rectifies the electric current transmitted from a rotary transformer 8′ to a secondary coil 7′ that is non-rotatably connected to the hollow rotor shaft 4′. The same is converted by the rectifier 6′ into direct current and passed on to the rotor winding 3′, as a result of which a magnetic field can be generated there. The secondary coil 7′ is part of a rotary transformer rotor 9′, which with a stationary rotary transformer stator 10′ forms the rotary transformer 8′. The rotary transformer stator 10′ has a transformer core 11′ and a primary coil 12′. The transformer core 11′ is formed from a magnetic core material for example a ferrite. The rotor 1′ is mounted via bearing 13′.

On each end-face of the rotor winding 3′, a winding head 1′ is provided, via which an electrical contacting with the rectifier 6′ takes place.

Disadvantageous in the rotor 1′ according to FIG. 1 known from the prior art is that the secondary coil 7′ has a comparatively large diameter outside the rotor shaft 4′, as a result of which on the one hand an enlarged installation space requirement is created and on the other hand comparatively high forces in the form of centrifugal forces acting on the secondary coil 7′ of the rotary transformer rotor 9′ develop during the operation. In addition to this, a stator field of the electric machine or synchronous machine 2′ can influence the function of the rotary transformer 8′ through parasitic effects, such as for example magnetic fields, which can likewise have a disadvantageous effect.

In the following, the rotor 1 according to the invention is now explained in more detail according to FIGS. 2 and 4 and the externally excited synchronous machine 2, likewise according to the invention, according to FIG. 4. It is noted here that the reference signs used with respect to FIG. 2 to 4 are used analogously to FIG. 1, however without apostrophe. In the following description, only a synchronous machine 2 is often referred to for easier readability, wherein it is obviously clear that the rotor 1 can also be employed for a traction motor for a motor vehicle or a servomotor.

In the rotor 1 for an externally excited electric synchronous machine 2 shown as per FIGS. 2 and 4, a hollow rotor shaft 4 with a rotor winding 3 arranged thereon is likewise provided. A rectifier 6 is electrically connected via the winding head 14 to the rotor winding 3. According to the invention, this rectifier 6 and a rotary transformer rotor 9 (see FIGS. 2 and 4) of a rotary transformer 8 (see FIG. 4) is now arranged with its secondary coil 7 in the hollow rotor shaft 4 and thus not only accommodated in an installation space-optimised manner but also comparatively protected from parasitic effects such as magnetic fields of a stator 15 of the synchronous machine 2 (see FIG. 4).

A further major advantage of the arrangement of the rotary transformer rotor 9 within the hollow rotor shaft 4 is the comparatively small diameter and thus distance of the secondary coil 7 from an axis of rotation 16, as a result of which the centrifugal forces acting on the secondary coil 7 during the operation of the synchronous machine 2 can likewise be reduced and thus a load acting on the secondary coil 7 and also on the rectifier 6 can be minimised which has a positive effect on the service life of such a synchronous machine 2.

In order to simplify an installation of the rectifier 6 and of the secondary coil 7 within the hollow rotor shaft 4, the rectifier 6 and the secondary coil 7 can also form a prefabricated assembly 17, which is fixed as a whole in the hollow rotor shaft 4. For realising the prefabricated assembly 17, the secondary coil 7 and the rectifier 6 can be glued, welded, soldered, screwed, pressed, clipped to one another and/or cast with one another in a plastic matrix. If a repair-friendly embodiment is desired, a clipping or screwing of the rectifier 6 to the secondary coil 7 is opportune, as a result of which for example in the case of a defective rectifier 6 the same can be exchanged, replaced with a new one and the secondary coil 7 continued to be used. By embedding both the secondary coil 7 and also the rectifier 6 in a plastic matrix, a coating in the manner of a protective layer can be additionally created, which not only protects the secondary coil 7 and electronic components such as for example diodes of the rectifier 6, but also electrically insulates these towards the surroundings.

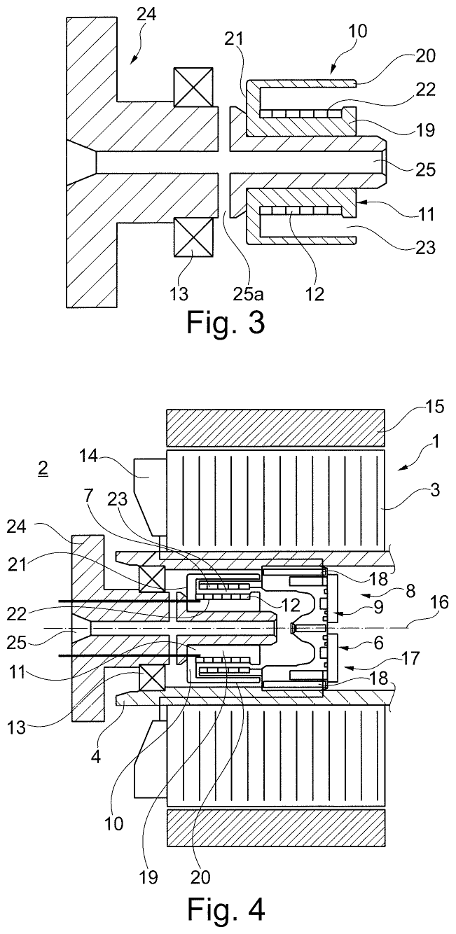

Viewing FIGS. 2 and 3 further it is noticeable that the assembly 17 comprises fluid-permeable openings 18, so that a coolant flowing in the hollow rotor shaft 4 can also penetrate the assembly 17. In order to negatively affect a coolant flow as little as possible in the process, the assembly 17 is preferentially configured so as to be favourable in terms of flow and comprises curves for example. Thus, pressure losses can also be minimised.

Viewing the secondary coil 7, further, it is noticeable that the same is annularly arranged about the axis of rotation 16 of the hollow rotor shaft 4. Through the annular arrangement of the secondary coil 7 about the axis of rotation 16, an annular cylinder-like embodiment can be selected which significantly simplifies an assembly later on.

Viewing the rotary transformer stator 10 according to FIGS. 3 and 4, it is noticeable that the same comprises a primary coil 12 and a transformer core 11 of a magnetic core material, for example a ferrite. The transformer core 11 has an inner ring 19, an outer ring 20 and a web 21 connecting the inner ring 19 and the outer ring 20 on an end-face in each case, wherein the primary coil 12 is arranged in a recess 22 on the inner ring 19.

Viewing FIGS. 3 and 4 in more detail, it is noticeable that between the inner ring 19 and the outer ring 20 an annular recess 23 is arranged, in which in the installed state the annular secondary coil 7 of the rotary transformer rotor 9 engages or dips. Thus, a particularly insulation space-optimised arrangement of the entire rotary transformer 8 within the hollow rotor shaft 4 can be achieved.

According to FIGS. 3 and 4, the rotary transformer stator 10 is arranged on a bearing pin 24, which carries a bearing 13 for mounting the rotor 1. The bearing pin 24 in turn has at least one cooling channel 25 for conducting coolant, wherein the cooling channel 25 can extend in the axial direction and transversely thereto and wherein in particular a cooling channel 25a extending transversely thereto can be used for cooling the bearings 13. The rotary transformer stator 11 is non-rotatably arranged on the bearing pin 24, wherein the bearing pin 24 is for example part of a bearing shield of the synchronous machine 2 or can be placed onto the same.

In order to reduce a magnetic air gap between the secondary coil 7 and the primary coil 12, the secondary coil 7 can also comprise a coating or be for example embedded in a plastic casing.

All in all the following advantages can be achieved with the rotor 1 according to the invention and the synchronous machine 2 according to the invention:
An improvement of the magnetic compatibility by arranging the rotary transformer 8 within the hollow rotor shaft 4 and thus an arrangement of the same protected from parasitic effects such as for example magnetic fields through the stator 15, since the rotor shaft 4 serves as shielding element.
An improvement of the mechanical stability since the rotary transformer rotor 9 has a comparatively small outer diameter and is thus subjected to significantly lower forces, in particular centrifugal forces than a rotary transformer rotor 9′ from the prior art to date arranged outside the rotor shaft 4.
An optimal utilisation of an installation space within the hollow rotor shaft 4 not utilised to date and thus the possibility of being able to build the synchronous machine 2 as a whole in a more compact manner.
A simple installation by sliding the rotary transformer rotor 9 and the rotary transformer stator 10 into one another in the hollow rotor shaft 4.
A further improvement of the mechanical stability because of a stationary and fixed transformer core 11.
A simple connection to a cooling circuit and thus an effective cooling of the synchronous machine 2 combined with a high efficiency of the same.

1. A rotor for an externally excited synchronous machine, comprising:
a rotor winding arranged on a hollow rotor shaft; and
a rectifier electrically connected to the rotor winding;
wherein the rectifier and a rotary transformer rotor of a rotary transformer with a secondary coil are arranged in the hollow rotor shaft.

2. The rotor according to claim 1, wherein the rectifier and the secondary coil form a prefabricated assembly.

3. The rotor according to claim 2, wherein the secondary coil and the rectifier are at least one of glued, welded, soldered, screwed, pressed, clipped, and cast with one another.

4. The rotor according to claim 3, wherein the prefabricated assembly includes a plurality of fluid-permeable openings via which a coolant is flowable in the hollow rotor shaft.

5. The rotor according to claim 1, wherein the secondary coil includes a coating and is electrically insulated relative to a surroundings.

6. The rotor according to claim 1, wherein the secondary coil is annularly arranged about an axis of rotation of the hollow rotor shaft.

7. An externally excited synchronous machine, a traction motor for a motor vehicle, or a servomotor, comprising:
an electrically energizable rotor according to claim 1; and
a rotary transformer stator arranged in the hollow rotor shaft.

8. The externally excited synchronous machine according to claim 7, wherein the rotary transformer stator includes a primary coil and a transformer core of a magnetic core material.

9. The externally excited synchronous machine according to claim 8, wherein:
the transformer core includes an inner ring, an outer ring, and a web connecting the inner ring and the outer ring on an end-face of the inner ring and an end-face of the outer ring;
the primary coil is arranged in a recess of the inner ring; and
between the inner ring and the outer ring, an annular recess is arranged.

10. The externally excited synchronous machine according to claim 9, wherein the secondary coil is annular and the secondary coil engages in the annular recess of the transformer core.

11. The externally excited synchronous machine according to claim 8, wherein the rotary transformer stator is arranged on a bearing pin projecting into the hollow rotor shaft for mounting the rotor.

12. The externally excited synchronous machine according to claim 11, wherein the bearing pin includes a cooling channel for conducting coolant.

13. The externally excited synchronous machine according to claim 12, wherein:
the cooling channel of the bearing pin extends in an axial direction of the hollow rotor shaft;
the bearing pin further includes a second cooling channel extending transversely to the cooling channel; and
the cooling channel and the second cooling channel are in fluid communication with one another.

14. The externally excited synchronous machine according to claim 13, further comprising at least one bearing arranged on the bearing pin, wherein the second cooling channel opens in a vicinity of the at least one bearing such that the at least one bearing is cooled via the coolant from the second cooling channel.

15. The externally excited synchronous machine according to claim 8, wherein the magnetic core material is a ferrite.

16. A rotor for an externally excited synchronous machine, comprising:
a hollow rotor shaft;
a rotor winding arranged on the hollow rotor shaft and extending around an outer circumference of the hollow rotor shaft;
a rectifier electrically connected to the rotor winding; and
a rotary transformer rotor of a rotary transformer, the rotary transformer rotor including a secondary coil;
wherein the rectifier, the rotary transformer rotor, and the secondary coil are arranged in the hollow rotor shaft.

17. The rotor according to claim 16, further comprising a winding head electrically connecting the rotor winding and the rectifier.

18. The rotor according to claim 16, wherein:
the rectifier and the secondary coil are connected to one another and are provided as a prefabricated assembly; and
the prefabricated assembly is fixed as a whole in the hollow rotor shaft.

19. The rotor according to claim 16, further comprising a plastic matrix in which both the rectifier and the secondary coil are embedded, wherein the rectifier and the secondary coil are electrically insulated from a surroundings via the plastic matrix.

20. The rotor according to claim 16, wherein the secondary coil extends circumferentially around an axis of rotation of the hollow rotor shaft.
